(19) United States
(12) Patent Application Publication
(10) Pub. No.: US 2011/0235865 A1
(43) Pub. Date: Sep. 29, 2011

(54) ADJUSTABLE RANGE FINDER AND THE METHOD THEREOF

(75) Inventors: Chih-Cheng Cheng, Taipei County (TW); Shyh-Haur Su, Hsinchu County (TW); Jwu-Sheng Hu, Hsinchu City (TW); Yu-Nan Pao, Hsinchu County (TW); Chin-Ju Hsu, Tainan City (TW); Yen-Chung Chang, Hsinchu City (TW)

(73) Assignee: INDUSTRIAL TECHNOLOGY RESEARCH INSTITUTE, Hsin-Chu (TW)

(21) Appl. No.: 12/792,445

(22) Filed: Jun. 2, 2010

(30) Foreign Application Priority Data
Mar. 26, 2010 (TW) 099109022

(51) Int. Cl. G06K 9/00

(52) U.S. Cl. 382/106

(57) ABSTRACT

An adjustable range finder and the method thereof are disclosed, in which the method comprising: projecting a first beam containing information of an object on a refractive optical element, being comprised a liquid-crystal layer, electrically connected to a voltage device, and a transmission blazed grating, so as to generate a second beam; enabling the voltage device to provide a first voltage to the liquid-crystal layer for forming an energy-concentrated M^{th}-order diffraction image by the projection of the second beam; adjusting and enabling the voltage device to provide a second voltage to the liquid-crystal layer for forming an energy-concentrated N^{th}-order diffraction image by the projection of the second beam; forming a series of images by the use of the M^{th}-order diffraction image and the N^{th}-order diffraction image; comparing the disparity between corresponding points in the series of images for obtaining the distance between the object and the refractive optical element.

### CROSS-REFERENCE TO RELATED APPLICATIONS

This non-provisional application claims priority under 35 U.S.C. §119(a) on Patent Application No(s). 099109022 filed in Taiwan, R.O.C. on Mar. 26, 2010, the entire contents of which are hereby incorporated by reference.

### TECHNICAL FIELD

The present disclosure relates to an adjustable range finder and the method thereof, and more particularly, to a stereovision ranging device and method for calculating distance between an object and a refractive optical element by comparing the disparity between corresponding points in at least two sets of images whereas the at least two sets of images are the result of the voltage-induced adjustment to the refraction angle of the refractive optical element.

### TECHNICAL BACKGROUND

With rapid advance of computer stereovision system, it is not only being used commonly in mobile robots for dealing with finding a part and orienting it for robotic handling or for obstacle detection, but also can be used in many human-machine interfaces such as in a vehicular vision system for enhancing driving safety. As for the range finding means that are currently used in the computer stereovision system, they can be divided and classified as the visual method and non-visual method, in which the visual method includes structural light analysis algorithm, disparity analysis algorithm, TOF (time of flight) principle and defocus-focus analysis algorithm, whereas the non-visual method includes acoustic wave detection, infrared detection, laser detection, and so on. It is noted that the performing of the visual method usually relies on the use of an optical imaging device for capturing images of a target at different focal distances so as to determine a range to the target based thereon, which can be a very slow process just to determine the range, not to mention that the optical imaging device can be very complex and bulky.

It is mots often that 3D stereo vision is achieved by the extraction of 3D information from images captured by the use of TLR (twin lens reflex) cameras. On the other hand, two cameras, displaced horizontally from one another are used to obtain images of differing views on the same scene, can also be used for achieving 3D stereo vision. Operationally, a computer is used for comparing the images while shifting the two images together over top of each other to find the parts that match, whereas the matching parts are referring as the corresponding points and the shifted amount is called the disparity. Accordingly, the disparity at which objects in the image best match and the featuring parameters of the cameras are used by the computer to calculate their distance. Nevertheless, for the images from TLR cameras, the core problem for achieving 3D stereo vision is to acquire the corresponding points from the captured images accurately and rapidly. For the two-camera system, the trade-off between the size of the system and the depth resolution of the system can achieve is the main concern for designing the system since the larger the base-line is designed between the two cameras, the smaller the depth resolution of the system can achieve. In addition, the working area of the two-camera system is restricted to the intersection of the field-of-views of the two cameras. Therefore, the performance of the two-camera system is greatly restricted since it can not detect whichever that is too close or too far away from the system.

### TECHNICAL SUMMARY

The present disclosure relates to an adjustable range finder and the method thereof, in which the adjustable range finder is substantially an adjustable single lens range finder configured with a refractive optical element, whereas the refractive optical element, being comprised of an optical grating, a liquid crystal layer and a polarizer, is featuring in that: the refraction angle of the refractive optical element is changed with the modulating of a voltage value applied thereon. By placing the refractive optical element in front of an imaging device that is between the imaging device and an object, an image of the object corresponding a specific refraction angle can be formed in the imaging device, and then by comparing the disparity between corresponding points in the two images of the object, i.e. the one formed with the specific refraction angle and another one without being deflected, the distance between the object and the refractive optical element can be obtained.

In an exemplary embodiment, the present disclosure provides an adjustable range finder, comprising:

a refractive optical element, further comprising a liquid-crystal layer, electrically connected to a voltage device, and a transmission blazed grating, provided for a first beam containing information relating to an object to pass therethrough so as to generate a second beam containing information relating to the object; and

an optical imaging device, provided for the second beam to projected thereon;

wherein, by enabling the voltage device to apply different voltages on the liquid crystal layer, a series of images can be formed by the projection of the second beam corresponding to the voltage variation, and thereby, a distance between the object and the refractive optical element is calculated and obtained basing upon the disparity comparison between corresponding points in the series of images.

In an exemplary embodiment, the present disclosure provides a method for adjustable range finder, comprising the steps of:

projecting a first beam containing information relating to an object on a refractive optical element, which is comprised: a liquid-crystal layer, electrically connected to a voltage device, and a transmission blazed grating, so as to generate a second beam containing information relating to the object;

enabling the voltage device to provide a first voltage to the liquid-crystal layer for forming an energy-concentrated M^{th}-order diffraction image by the projection of the second beam upon an optical imaging device;

adjusting the voltage device for enabling the same to provide a second voltage to the liquid-crystal layer for forming an energy-concentrated N^{th}-order diffraction image by the projection of the second beam upon the optical imaging device;

forming a series of images by the use of the M^{th}-order diffraction image and the N^{th}-order diffraction image; and

comparing the disparity between corresponding points in the series of images so as to obtain the distance between the object and the optical refraction element.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing an adjustable range finder according to an embodiment of the present disclosure.

FIG. 2 is a schematic diagram showing a refractive optical element according to an embodiment of the present disclosure.

FIG. 3 is a schematic diagram showing a refraction angle of a liquid crystal in a liquid crystal layer relating to its substrate.

FIG. 4 is a diagram of an experiment showing the relationship between actual disparity and simulated disparity when the refraction angle is 7.5 degrees.

FIG. 5 is a curve diagram showing the relationship between the transmission and the effective refractive index with respect to different diffraction images of different orders under different voltages.

FIG. 6 is a schematic diagram showing the diffraction of a grating.

FIG. 7 is a schematic diagram showing a transmission blazed grating.

FIG. 8 is a diagram showing the relationship between image offset and target distance in the present disclosure.

FIG. 9 is a schematic diagram showing how a blazed grating and an image sensing array are orientated with respect to each other in the present disclosure.

FIG. 10 is a schematic diagram showing how diffraction images resulting from the used of system of FIG. 9 are used for constructing a 3D stereovision.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

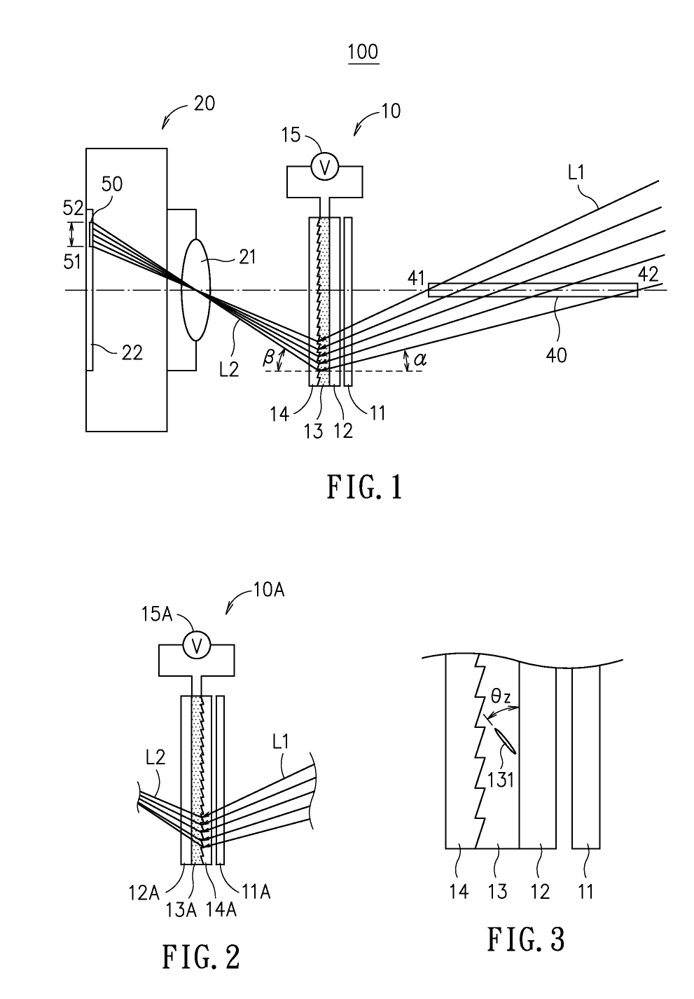

Please refer to FIG. 1, which is a schematic diagram showing an adjustable range finder according to an embodiment of the present disclosure. In FIG. 1, an adjustable range finder 100 is primarily comprised of: a refractive optical element 10 and an optical imaging device 20. Moreover, the refractive optical element 10 is comprised a polarizer 11, a transparent substrate 12, a liquid crystal layer 13 and a transmission blazed grating 14, in which the liquid crystal layer 13 is further connected to a voltage device 15. The polarizer 11 is used for eliminating the zero-order image of an object resulting from the O-ray in higher order image formation, so that the difficulty of image processing for the image formation can be reduced. The transparent substrate 12 is used as the substrate of the liquid crystal layer 13, which is provided sandwiched liquid crystal layer 13 between the transparent substrate 12 and the transmission blazed grating 14. Moreover, the transparent substrate 12 can be made of any transparent material, such as glass. In addition, through the transparent substrate 12 and the transmission blazed grating 14, the voltage of the voltage device 15 can be transmitted to the liquid crystal layer 13.

As shown in FIG. 1, a first beam L1 is projected toward the refractive optical element 10 where it is converted into a second beam L2, projecting toward the optical imaging device 20. In the embodiment shown in FIG. 1, the first beam L1 is projected sequentially passing through the polarizer 11, the transparent substrate 12, the liquid crystal layer 13, and the transmission blazed grating 14. However, the projection of the first beam L1 is not limited thereby, by exchanging the transparent substrate 12 and the transmission blazed grating 14 while maintaining the liquid crystal layer 13 to be sandwiched between the two, the first beam L1 can be projected sequentially through the polarizer 11A, the transmission blazed grating 14A, the liquid crystal layer 13A and the transparent substrate 12A, as shown in FIG. 2. Similarly, the liquid crystal layer 13a is electrically connected to a voltage device 15A, by that the refractive optical element 10A is able to perform the same as the refractive optical element 10 shown in FIG. 1. Moreover, the optical imaging device 20 is further comprised: an image sensor 22, and a lens 21, in which the lens 21 is disposed on the optical path of the second beam L2 as it is projecting toward the image sensor 22 while allowing the second beam L2 to be projected passing through the lens 21 and then travel toward the image sensor 22 for forming the image therein. It is noted that the image sensor 22 can be a charge-coupled device (CCD) or a complementary metal-oxide semiconductor (CMOS).

The connecting of the liquid crystal layer 13 to a voltage device 15 is for utilizing one characteristic of the liquid crystal, that is, for enabling the refractive index of the liquid crystal to be modulated according to the variation of the voltage applied across the liquid crystal. When the voltage from the voltage device 15 is changed, liquid crystal molecules in the liquid crystal layer 13 will be reoriented according to the applied voltage, so that the effective refractive index of the liquid crystal layer 13 is changed accordingly. Please refer to FIG. 3, which is a schematic diagram showing a refraction angle of a liquid crystal in a liquid crystal layer relating to its substrate. In FIG. 3, one liquid crystal molecule 131 in the liquid crystal layer 13 is aligned for forming an included angle, referring as a refraction angle θ_{z}, between the axis thereof and the substrate 12. When the refraction angle θ_{z} is changed with the changing of the voltage, the order of the diffraction image that is formed on the image sensor 22 is changed according to the following equation of refraction index:

$${n}_{eff} ( {θ}_{z} ) = \frac{{n}_{o} {n}_{e}}{{( {n}_{o}^{2} {cos}^{2} {θ}_{z} + {n}_{e}^{2} {sin}^{2} {θ}_{z} )}^{\frac{1}{2}}} \qquad ( 1 )$$

wherein
n_{eff} represents the effective refractive index;
θ_{z} represents the refraction angle;
nₒ is an O-ray refractive index;
nₑ is an E-ray refractive index;

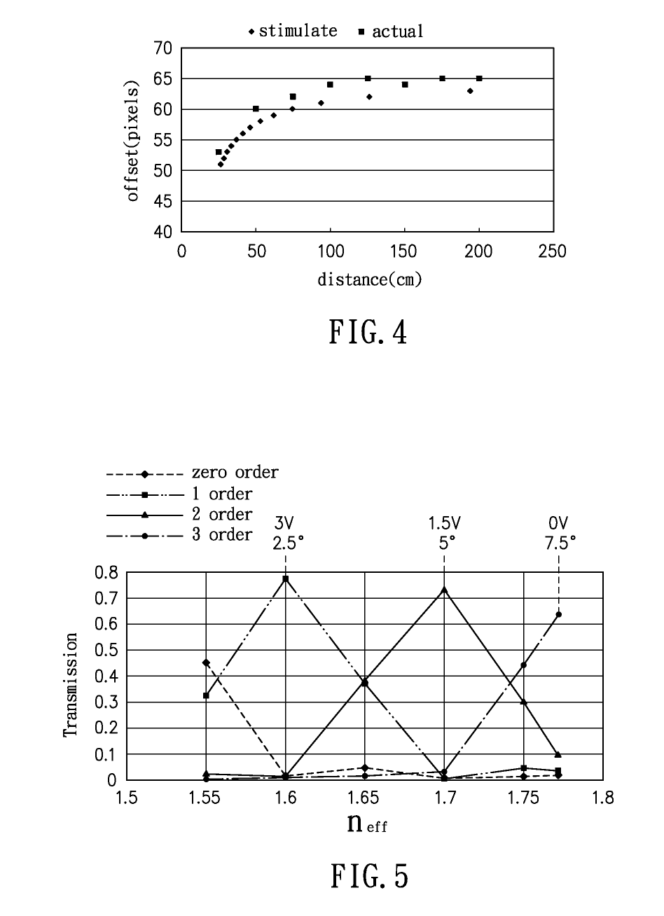

Please refer to FIG. 4, which is a diagram of an experiment showing the relationship between actual disparity and simulated disparity when the refraction angle θ_{z} is 7.5 degrees. From the experiment shown in FIG. 4, it is noted that the refractive index of the liquid crystal layer 13 can be varied with the changing of voltage from the voltage device 15. Please refer to FIG. 5, which is a curve diagram showing the relationship between the transmission and the effective refractive index with respect to different diffraction images of different orders under different voltages. As shown in FIG. 5, as the liquid crystal layer 13 will be oriented to different refraction angles θ_{z}, i.e. 7.5°, 5° and 2.5°, under different voltage, i.e. 0V, 1.5V, and 3V in this embodiment, the diffraction images of different orders, i.e. 0˜3^{rd} order in this embodiment, will have different effective refractive indexes and transmissions that enables disparities to exist between those diffraction images of different orders, and thus, by comparing the disparity between corresponding points in those images, the distance between the object and the refractive optical element can be obtained. It is noted that the present disclosure is not limited by the curve diagram shown in FIG. 5, which uses the transmission blazed grating 14 featured by three levels of diffraction orders, but can use other transmission blazed gratings featured by different levels of diffraction orders, e.g. five levels.

Since the transmission blazed grating 14 used in the refractive optical element 10 of the present disclosure is characterized in that: it can change the traveling direction of an incident light for concentrating energy to a specific order of diffraction and thus enhance the image resulting from that order of diffraction while simultaneously enabling the other orders of diffraction with lower energy concentration to form images. Moreover, the diffraction angles for each order of diffraction of different wavelengths can be induced under equal optical path difference condition according to the following grating equation:

d(sin α±sin β)=mλ (2)

wherein
α: the angle between the incident light and the normal to the grating (the incident angle)
β: the angle between the diffracted light and the normal to the grating (the diffraction angle)
d: spacing between the slits (the grating period)
m: order of diffraction (m=0, ±1, ±2, . . . )
λ: wavelength.

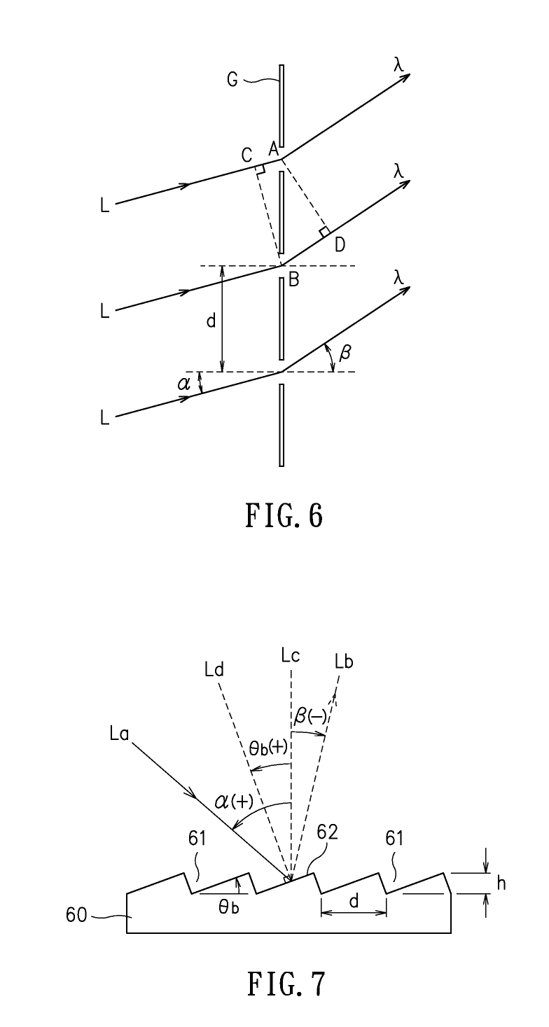

As shown in FIG. 6, when the optical path difference between the path representing by the line B̅D̅ and the path representing by the line C̅A̅ is an integer multiple of the wavelength λ as the resulting of the light L travelling passing the grating G, there will be constructive interference that fulfills the aforesaid grating equation (2).

As diffractive optical element is usually being used for light splitting or for changing the light traveling direction, the diffraction efficiency is an important operation factor as it is a value that expresses the extent to which energy can be obtained from diffracted light with respect to the energy of the incident light. A blazed grating is a special type of diffraction grating that can have good diffraction efficiency and good light-splitting effect. In a blazed grating, by the adjusting of the relative angle between an incident light and its grating facet, the diffracted light is directed to travel at a direction the same as the light being reflected by the facet. As shown in FIG. 7, a blazed grating 60 is formed with grooves 61 that have a sawtooth profile. Each groove 61 is comprised a facet 62, whereas each facet 62 can be substantially a micro mirror for concentrating most of the energy into a specific ordered diffracted light. In FIG. 7, light La is directed at a facet 62 at angle α and light of wavelength λ is diffracted into diffracted light Lb at angle β. Here, α and β are the angles made with the normal to the grating and counterclockwise direction is taken as positive. Moreover, d represents the spacing between the slits, i.e. the grating period. When the relationship between the incident light and the m^{th}-order diffracted light describes mirror reflection with respect to the facet surface of the grooves, most of the energy is concentrated into the m^{th}-order diffracted light and thus the facet angle of the grooves at this point is called the blaze angle, and, represented by θ_{B}, satisfies the following:

α−θ_{b}=θ_{b}−β, or θ_{b}=(α+β)/2 (3)

Combining equations (3) and (4) gives the following:

d(sin α−sin(α−2θ_{b}))=mλ (4)

According to the aforesaid equation (4), a transmission blazed grating of a specific blazed angle can be designed for a light of specific blazed wavelength, as the transmission blazed grating 14 in the refractive optical element 10 shown in FIG. 1. As shown in FIG. 7, the blazed grating is able to concentrate most of the energy for beams of different wavelengths into a specific ordered diffracted light by adjusting its depth h and the grating period d.

With reference to FIG. 1, the following description is provided for illustrating the imaging principle of the present disclosure. After the first beam L1 is projected on an object 40, the first beam L1 containing information relating to the object 40 is projected to the refractive optical element 10 by an incident angle α and passing sequentially through the polarizer 11, the transmission substrate 12, the liquid crystal layer 13 and the transmission blazed grating 14. Thereafter, it is further projected out of the refractive optical element 10 by a diffraction angle β while being converted into a second beam L2 which also contains information relating to the object 40. The second beam L2 is then being directed toward the optical imaging device 20, in which the second beam L2 will first enter the lens 21 and then into the image sensor 22 where it is used for formed a diffraction image 50 therein. As shown in FIG. 1, the object 40 is constructed with a first end 41 and a second end 42, and correspondingly that the diffraction image 50 has a first image end 51 and a second image end 52. In addition, during the projection of the first beam L1, the voltage device 15 will applied a voltage across the liquid crystal layer 13. It is noted that the voltage being applied is not restricted to any value, but can be any voltage value as required and specified by the order of diffraction. As shown in FIG. 4, when 3V is provided, the refractive optical element 10 will concentrate most of the energy for beams of different wavelengths into a first ordered diffracted light; and when 1.5V is provided, the refractive optical element 10 will concentrate most of the energy for beams of different wavelengths into a second ordered diffracted light; and when 0V is provided, the refractive optical element 10 will concentrate most of the energy for beams of different wavelengths into a third ordered diffracted light. It is noted that the zero-ordered curve of diffraction is related to the image formation without the refractive optical element 10, that is, it is related to the so-called actual images formed by projecting the first beam L1 directly into the optical imaging device 20 where it will travel passing through the lens 21 and projected upon the image sensor 22 for forming an actual image of the object.

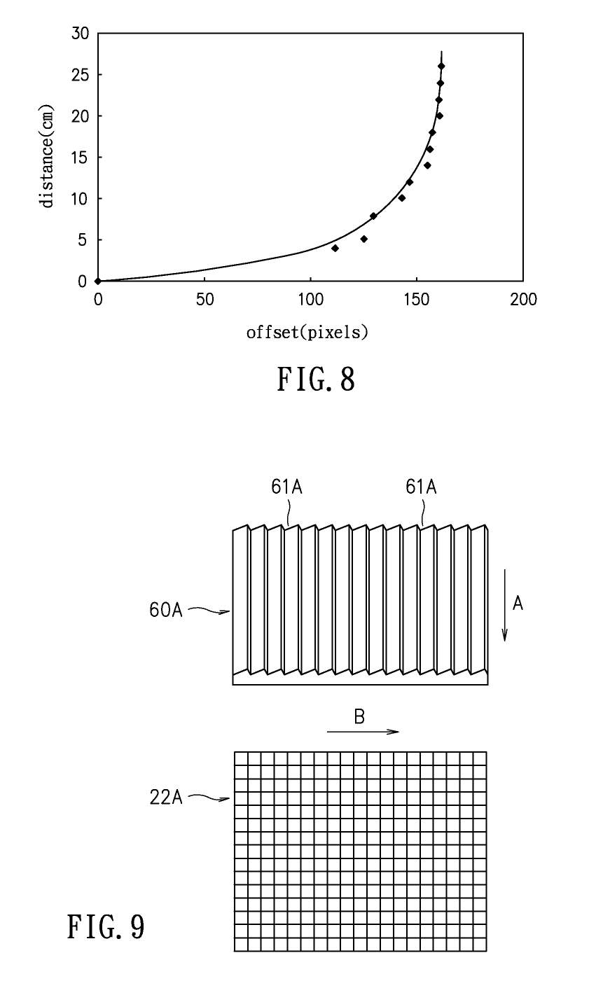

As the refraction angle of the refractive optical element 10 can be modulated with the changing of the voltage applied thereon, most of the energy for beams of different wavelengths will be concentrated into a specified ordered diffracted light according to the applied voltages. For instance, when the output of the voltage device 15 is adjusted for enabling the same to output a first voltage and a second voltage, the refractive optical element 10 will concentrate most of the energy for beams of different wavelengths into two different orders of diffraction to be used for forming diffraction images of different orders, such as a M^{th}-order diffraction image and a N^{th}-order diffraction image. In this embodiment, the M^{th}-order diffraction image is substantially a first order diffraction image while the N^{th}-order diffraction image is the zero order diffraction image. Thereafter, by combining the aforesaid M^{th}-order diffraction image with the N^{th}-order diffraction image, a series of images can be formed. Accordingly, by comparing the disparity between corresponding points in the series of images, i.e. the 1^{st}-order diffraction image 50 and the zero order diffraction image, the distance between the object 40 and the refractive optical element 10 can be obtained. In the other embodiments, it is possible to design two different refractive optical elements using different parameters for concentrating energy at different orders of diffraction and thereby generating two different diffraction images accordingly, and then, similarly by comparing the disparity between corresponding points in the two diffraction images, the distance between the object 40 and the refractive optical element 10 can be obtained. In another word, the 1^{st}-order diffraction image 50 that is formed in the stereovision system with the diffractive optical element and the zero order diffraction image that is formed without the diffractive optical element are used for acting exactly as the left-eye image and right-eye image similar to human binocular vision, which is also true for the two different diffraction images resulting from the use of two diffractive optical elements using different parameters for concentrating energy at different orders of diffraction. It is noted that the stereovision system of the present disclosure is not restricted by having to specifically design its diffractive optical element 10 for concentrating energy to any specific order of diffraction, i.e. the M^{th}-order of diffraction as well as the N^{th}-order of diffraction can be any two different orders of diffraction according to actual requirement. Please refer to FIG. 8, which shows the relation between offset and target distance in the stereovision system of the present disclosure. As shown in FIG. 8, when the image offset is 125 pixels, the obtained distance is 5 cm; and when the image offset is 150 pixels, the obtained distance is 14 cm. Thus, the present disclosure is characterized in that: as the refractive optical element 10 is configured with a liquid crystal layer 13 in which the orientation of its liquid crystal molecules can be adjusted according to the voltage applied thereon, the refraction angle of the refractive optical element 10 can be modulated by the voltage device 15 and thus different diffraction images of different orders can be formed simply by changing the output voltage of the voltage device 15.

It is noted that the stereovision system of the present disclosure can use any type of refractive optical element, only if it is capable of concentrating energy into its required order of diffraction. However, in order to prevent the images of multiple orders of diffraction to overlap with one another and thus cause difficulties to the posterior image analysis, the transmission of the refractive optical element relating to the specified order of diffraction should be higher than 0.5. Please refer to FIG. 9, which is a schematic diagram showing how a blazed grating and an image sensing array are orientated with respect to each other in the stereovision system of the present disclosure. The blazed grating 60A shown in FIG. 9, being a grating having cross section similar to the blazed grating 60 shown in FIG. 7, is formed as a ruled grating comprising a plurality of strip-like grooves 61A arranged parallel to a first direction A. Moreover, the optical imaging device 22A paired with the blazed grating 60A is featured by a pixel orientation direction B and the pixel orientation direction B, being the scan line direction of the optical imaging device 22A, is disposed perpendicular to the first direction A. In this embodiment, the first direction A is vertically oriented while the pixel orientation direction B is horizontally oriented, by that the M^{th}-order diffraction image and the N^{th}-order diffraction image are located on the same scan line.

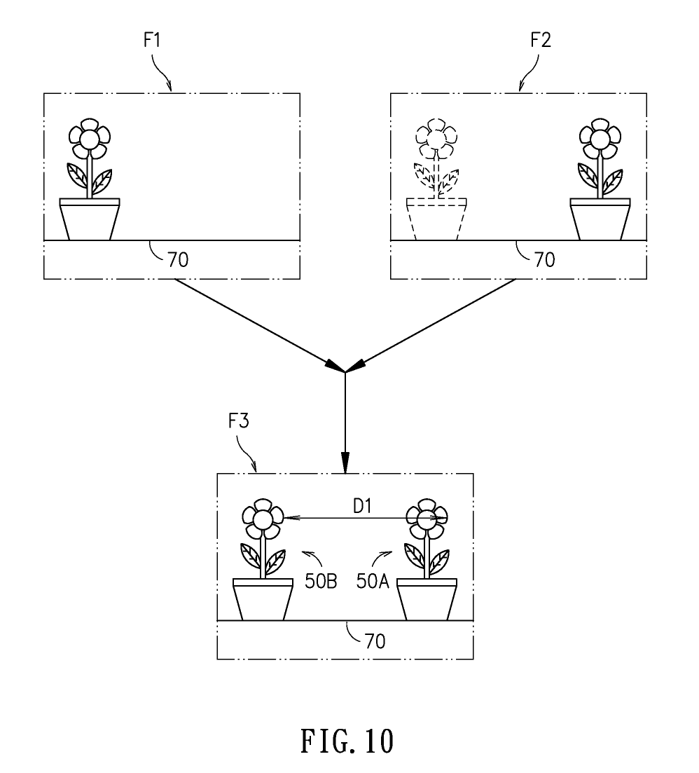

Please refer to FIG. 10, which is a schematic diagram showing how diffraction images resulting from the used of system of FIG. 9 are used for constructing a 3D stereovision. In FIG. 10, the images defined by solid lines are those formed from energy-concentrated diffracted light while those defined by dotted lines are those formed from diffracted light of lower energy. Moreover, the first set of images F1 is obtained without the use of any refractive optical element, that is, they are zero-order diffraction images as N=0, in which the solid flowerpot is an energy-concentrated real image. Nevertheless, the second set of images F2 is obtained with the use of an refractive optical element, that is, when M=1 for example, the solid flowerpot at the right is an energy-concentrated 1^{st}-order diffraction image that is a virtual image while the dotted flowerpot at the left is a zero order diffraction image of lower energy which is a real image. By combining the first set of images F1 and the second set of images F2 into a series of images by superimposing the first set of images F1 on the second set of images F2, a third set of images F3 can be obtained. On the same scan line 70 in the third set of images F3, one energy-concentrated 1^{st}-order image 50A and one energy-concentrated zero order image 50B can be obtained, and thereby, by measuring the disparity D1 between corresponding points in the 1^{st}-order image 50A and the zero order image 50B, the distance between the real flowerpot and the diffractive optical element can be calculated and thus obtained. It is noted that although the stereovision system of the present disclosure is capable of performing well under common ambient lighting condition, there can be an active light source in the system to be used as an auxiliary light source for enhancing images of the object. Moreover, the active light source can be a visible light source or an invisible light source.

To sum up, the present disclosure provides an adjustable range finder and the method thereof, that are capable of calculating distance between an object and a refractive optical element by comparing the disparity between corresponding points in at least two sets of images whereas the at least two sets of images are the result of the voltage-induced adjustment to the refraction angle of the refractive optical element. It is noted that as the refraction angle of the refractive optical element can be modulated by the voltage device for enabling different diffraction images of different orders to be formed simply by changing the output voltage of the voltage device, not only measurements using the adjustable range finder can be performed rapidly, but also it can be constructed with comparatively simpler framework for miniaturization.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An adjustable range finder, comprising:
a refractive optical element, further comprising a liquid-crystal layer, electrically connected to a voltage device, and a transmission blazed grating, provided for a first beam containing information relating to an object to pass therethrough so as to generate a second beam containing information relating to the object; and
an optical imaging device, provided for the second beam to projected thereon;
wherein, by enabling the voltage device to apply different voltages on the liquid crystal layer, a series of images can be formed by the projection of the second beam corresponding to the voltage variation, and thereby, a distance between the object and the refractive optical element is calculated and obtained basing upon the disparity comparison between corresponding points in the series of images.

2. The adjustable range finder of claim 1, wherein the refractive optical element further comprises: a transparent substrate, provided for sandwiching the liquid crystal layer between the transparent substrate and the transmission blazed grating.

3. The adjustable range finder of claim 1, wherein the refractive optical element further comprises: a polarizer, disposed at a position enabling the first beam to pass through the polarizer before entering into the refractive optical element.

4. The adjustable range finder of claim 1, wherein the optical imaging device further comprises:
an image sensor, for forming the series of images by the projection of the second beam; and
a lens, disposed on the optical path of the second beam traveling toward the image sensor in a manner that the second beam will travel passing the lens before being projected on the image sensor.

5. A method for adjustable range finder, comprising the steps of:
projecting a first beam containing information relating to an object on a refractive optical element, which is comprised: a liquid-crystal layer, electrically connected to a voltage device, and a transmission blazed grating, so as to generate a second beam containing information relating to the object;
enabling the voltage device to provide a first voltage to the liquid-crystal layer for forming an energy-concentrated M^{th}-order diffraction image by the projection of the second beam upon an optical imaging device;
adjusting the voltage device for enabling the same to provide a second voltage to the liquid-crystal layer for forming an energy-concentrated N^{th}-order diffraction image by the projection of the second beam upon the optical imaging device;
forming a series of images by the use of the M^{th}-order diffraction image and the N^{th}-order diffraction image; and
comparing the disparity between corresponding points in the series of images so as to obtain the distance between the object and the refractive optical element.

6. The method of claim 5, wherein the refractive optical element further comprises: a transparent substrate, provided for sandwiching the liquid crystal layer between the transparent substrate and the transmission blazed grating.

7. The method of claim 5, wherein the refractive optical element further comprises: a polarizer, disposed at a position enabling the first beam to pass through the polarizer before entering into the refractive optical element.

8. The method of claim 5, wherein the aforesaid M and N represent different orders of diffraction.

9. The method of claim 5, wherein the series of images is formed by superimposing the M^{th}-order diffraction image on the N^{th}-order diffraction image.

10. The method of claim 5, wherein the transmission of the diffractive optical element relating to the M^{th}-order diffraction image is higher than 0.5, and that is also true for the N^{th}-order diffraction image.
